(19) United States
(12) Patent Application Publication
(10) Pub. No.: US 2026/0163995 A1
(43) Pub. Date: Jun. 11, 2026

(54) IMAGING DEVICE, IMAGING METHOD, PROGRAM, AND IMAGE PROCESSING METHOD AND PROGRAM

(71) Applicant: Sony Group Corporation, Tokyo (JP)

(72) Inventor: Masafumi Wakazono, Tokyo (JP)

(21) Appl. No.: 18/998,695

(22) PCT Filed: Aug. 7, 2023
(86) PCT No.: PCT/JP2023/028736

§ 371 Date: Jan. 27, 2025

(30) Foreign Application Priority Data
Aug. 23, 2022 (JP) 2022-132439

(51) Int. Cl. H04N 5/917; H04N 19/63; H04N 23/62

(52) U.S. Cl. CPC H04N 5/917; H04N 19/63; H04N 23/62

(57) ABSTRACT

Image processing with reduced data size of a RAW image while suppressing a deterioration in image quality of a developed image is disclosed. In one example, an input unit of a touch panel acquires a development size corresponding to an image size at the time of development of the RAW image. A lossy compression unit compresses the captured image at a compression ratio corresponding to the development size and by a compression method that compressing an image by decomposing the image into a plurality of spatial frequency components to generate the RAW image. The compression ratio increases as the development size decreases. The technology can be applied to, for example, an imaging device that captures an image and records a RAW image or the like.

### TECHNICAL FIELD

The present technology relates to an imaging device, an imaging method, a program, and an image processing method and a program, and more particularly, to an imaging device, an imaging method, a program, and an image processing method and a program capable of reducing the data size of a RAW image while suppressing a deterioration in image quality of a developed image in a case where a captured image is compressed by a compression method that compresses an image by decomposing the image into a plurality of spatial frequency components to generate the RAW image.

### BACKGROUND ART

Imaging devices that capture, compress, and record images are becoming widespread. An imaging element that captures a moving image, downscales the moving image for simple compression, and records the compressed moving image has also been devised (see, for example, Patent Document 1).

Meanwhile, in such an imaging device, there is a case where a RAW image generated from a captured image is recorded. The RAW image is an image treated as an undeveloped image by development software. Typically, the RAW image is a captured image captured by an image sensor (hereinafter, also simply referred to as captured image) and recorded as it is without applying development processing in an imaging device. A developed image is obtained from the RAW image by performing the development processing with development software. Moreover, various development parameters are provided in the development software, allowing the user to freely adjust the developed image. Furthermore, an image resulting from performing visually lossless transformation processing on a captured image from the perspective of color reproduction is also treated as the RAW image. Examples of the transformation processing include processing for adjusting white balance, non-linear transformation processing using a Log curve, and the like. Since such transformation processing can be offset by performing inverse transformation processing at the time of development, it can be treated as equivalent to a captured image that is not subjected to the transformation processing. Therefore, in the development software, not only a captured image but also a captured image subjected to the lossless transformation processing is treated as a RAW image.

Note that a developed image is usually generated by performing many lossy processes on a RAW image, which makes it impossible to restore an image sufficiently close to the captured image from the developed image. Therefore, the developed image cannot be treated as a RAW image.

As a method for reducing the data size of such a RAW image, various methods have been proposed. For example, in a case where a developed image can be low in pixel count, there is a method to reduce the data size (file size) of a RAW image by generating a RAW image with a development size that is an image size indicating the pixel count of the developed image. Under this method, for example, a capture size that is an image size of a captured image is reduced to the development size by downscaling processing, demosaicing processing, or the like that does not affect color reconstruction, and the captured image is compressed by a lossless joint photographic experts group (JPEG) method or the like to generate a RAW image. It is therefore possible to reduce both the data size of a RAW image and a development load.

Furthermore, there is also a method to reduce the data size of a RAW image by lossy compressing a captured image by a compression method using a wavelet transform without changing the image size to generate a RAW image. Compression by a compression method using a wavelet transform (hereinafter, referred to as wavelet compression) corresponds to compression utilizing a spatial correlation in an image. Specifically, in wavelet compression, an image is decomposed into a plurality of spatial frequency components for compression.

This method maintains the image size of the RAW image identical to the capture size. Furthermore, it is possible to extract, by applying the mechanism of decomposing spatial frequency components, a RAW image with fewer pixels than the original RAW image at the time of decompression of wavelet compression and to perform development processing with fewer pixels than the original RAW image (hereinafter, referred to as development at a reduced size). That is, the data size of a RAW image can be reduced, whether development is performed at a reduced size or at full scale.

### CITATION LIST

### Patent Document

Patent Document 1: Japanese Patent Application Laid-Open No. 2017-135760

### SUMMARY OF THE INVENTION

### Problems to be Solved by the Invention

Under this method, however, a captured image is lossy compressed, so that the larger the compression ratio, the more the image quality of the developed image deteriorates. It is therefore difficult to reduce the data size of the RAW image by increasing the compression ratio.

Therefore, in a case where a captured image is compressed by a compression method that compresses an image by decomposing the image into a plurality of spatial frequency components, such as a compression method using a wavelet transform, to generate a RAW image, it is desired to provide a method to reduce the data size of the RAW image while suppressing a deterioration in image quality of a developed image, but such a demand is not being sufficiently met.

The present technology has been made in view of such circumstances, and it is therefore an object of the present technology to reduce, in a case where a captured image is compressed by a compression method that compresses an image by decomposing the image into a plurality of spatial frequency components to generate a RAW image, the data size of the RAW image while suppressing a deterioration in image quality of a developed image.

### Solutions to Problems

An imaging device or a program according to a first aspect of the present technology is an imaging device including: an acquisition unit that acquires a development size corresponding to an image size at the time of development of a RAW image; and a compression unit that compresses a captured image at a compression ratio corresponding to the development size acquired by the acquisition unit and by a compression method that compresses an image by decomposing the image into a plurality of spatial frequency components to generate the RAW image, in which the compression ratio increases as the development size decreases, or a program causing a computer to function as the imaging device.

An imaging method according to the first aspect of the present technology includes: by the imaging device, acquiring, a development size corresponding an image size at the time of development of a RAW image; and compressing, a captured image at a compression ratio corresponding to the development size acquired in the acquiring and by a compression method that compresses an image by decomposing the image into a plurality of spatial frequency components to generate the RAW image,, in which the compression ratio increases as the development size decreases.

In the first aspect of the present technology, a development size corresponding an image size at the time of development of a RAW image is acquired, and a captured image is compressed at a compression ratio corresponding to the development size and by a compression method that compresses an image by decomposing the image into a plurality of spatial frequency components to generate the RAW image. The compression ratio increases as the development size decreases.

An image processing method according to a second aspect of the present technology includes: acquiring, by an image processing device, size information indicating a development size corresponding to an image size at the time of development of a RAW image, and the RAW image corresponding to a captured image compressed at a compression ratio corresponding to the development size and by a compression method that compresses an image by decomposing the image into a plurality of spatial frequency components; and developing, by the image processing device, the RAW image acquired in the acquiring to generate a developed image with the development size indicated by the size information acquired in the acquiring by decompressing the RAW image on the basis of the development size, in which the compression ratio increases as the development size decreases.

A program according to the second aspect of the present technology is a program causing a computer to function as the image processing device, the image processing device including: an acquisition unit that acquires size information indicating a development size corresponding to an image size at the time of development of a RAW image, and the RAW image corresponding to a captured image compressed at a compression ratio corresponding to the development size and by a compression method that compresses an image by decomposing the image into a plurality of spatial frequency components; and a development unit that decompresses the RAW image acquired by the acquisition unit to generate a developed image with the development size indicated by the size information acquired by the acquisition unit on the basis of the development size, in which the compression ratio increases as the development size decreases.

In the second aspect of the present technology, size information indicating a development size corresponding to an image size at the time of development of a RAW image and the RAW image corresponding to a captured image compressed at a compression ratio corresponding to the development size and by a compression method that compresses an image by decomposing the image into a plurality of spatial frequency components are acquired, and the RAW image is decompressed on the basis of the development size indicated by the size information to generate a developed image with the development size. The compression ratio increases as the development size decreases.

### BRIEF DESCRIPTION OF DRAWINGS

FIG. 1 is a block diagram illustrating a configuration example of an imaging device according to an embodiment to which the present technology is applied.

FIG. 2 is a block diagram illustrating a configuration example of a lossy compression unit.

FIG. 3 is a diagram illustrating an example of a compression ratio table.

FIG. 4 is a diagram illustrating a first example of a recording method setting screen.

FIG. 5 is a diagram illustrating a second example of the recording method setting screen.

FIG. 6 is a flowchart for describing setting processing.

FIG. 7 is a flowchart for describing lossy compression processing.

FIG. 8 is a block diagram illustrating a configuration example of an embodiment of a developing device as an image processing device to which the present technology is applied.

FIG. 9 is a block diagram illustrating a configuration example of a lossy compressed RAW processing unit.

FIG. 10 is a diagram illustrating a relationship between a RAW image recording method and the presence or absence of downscaling at the time of recording and development.

FIG. 11 is a diagram illustrating processing of the imaging and developing devices.

FIG. 12 is a diagram illustrating an example of processing of other imaging and developing devices.

FIG. 13 is a diagram illustrating an example of processing of still other imaging and developing devices. FIG. 14 is a diagram for comparing the processing and processing results of FIGS. 11 to 13.

FIG. 15 is a flowchart for describing update processing.

FIG. 16 is a flowchart for describing lossy compressed RAW development processing.

FIG. 17 is a block diagram illustrating a configuration example of hardware of a computer.

### MODE FOR CARRYING OUT THE INVENTION

Hereinafter, a mode for carrying out the present technology (hereinafter, referred to as an embodiment) will be described. Note that the description will be made in the following order.
1. One embodiment
2. Computer

### One Embodiment

### Configuration Example of Imaging Device

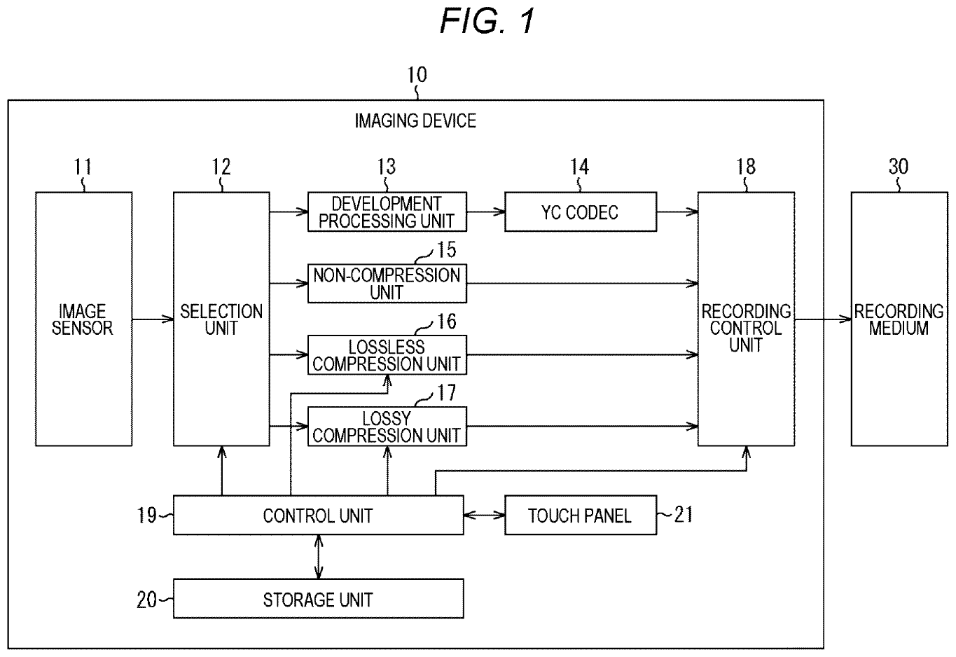

FIG. 1 is a block diagram illustrating a configuration example of an imaging device according to an embodiment to which the present technology is applied.

The imaging device 10 in FIG. 1 includes an image sensor 11, a selection unit 12, a development processing unit 13, a YC codec 14, a non-compression unit 15, a lossless compression unit 16, a lossy compression unit 17, a recording control unit 18, a control unit 19, a storage unit 20, and a touch panel 21. The imaging device 10 captures an image, and records a developed image resulting from developing the captured image or a RAW image generated from the captured image on a recording medium 30.

The image sensor 11 (imaging unit) captures an image of a subject to acquire (an analog signal of) a captured image, which is a Bayer image, and provides the captured image to the selection unit 12.

The selection unit 12 provides the captured image provided from the image sensor 11 to the development processing unit 13. The selection unit 12 provides the captured image provided from the image sensor 11 to the development processing unit 13, the non-compression unit 15, the lossless compression unit 16, or the lossy compression unit 17 on the basis of a selection signal provided from the control unit 19.

The development processing unit 13 performs development processing on the captured image provided from the selection unit 12 to generate a developed image. The development processing is, for example, processing of converting a Bayer image into a YCbCr image. The development processing unit 13 provides the developed image to the YC codec 14.

The YC codec 14 performs quantization and JPEG encoding on the developed image provided from the development processing unit 13 to generate a JPEG image. The YC codec 14 provides the JPEG image to the recording control unit 18. Note that the encoding method applied to the YC codec 14 may be H.265. In this case, the YC codec 14 generates a high efficiency image file format (HEIF) image from the developed image and provides the HEIF image to the recording control unit 18.

The non-compression unit 15 performs non-compression processing of performing quantization and encoding without compression on the captured image provided from the selection unit 12 to generate a RAW image. The non-compression unit 15 provides the RAW image to the recording control unit 18.

The lossless compression unit 16 performs, on the captured image provided from the selection unit 12, lossless compression processing of reducing the image size to the development size as necessary and compressing the captured image by a lossless compression method such as a lossless JPEG method to generate a RAW image on the basis of a development size provided from the control unit 19.

Specifically, the lossless compression unit 16 generates a captured image with the development size by performing downscaling processing, demosaicing processing, or the like on the captured image on the basis of the development size smaller than or equal to a capture size provided from the control unit 19. Then, the lossless compression unit 16 compresses the captured image by a lossless compression method to generate a RAW image with the development size. The lossless compression unit 16 provides the RAW image to the recording control unit 18.

Note that the lossless compression unit 16 may convert the captured image, which is a Bayer image, into a YCbCr image before the downscaling processing. At this time, a Y signal, which is luminance information, and a Cb signal and a Cr signal, which are color information, of the YCbCr image may be made different in resolution. For example, the resolution of the Y signal is the development size, but the resolutions of the Cb signal and the Cr signal can be made smaller than the development size.

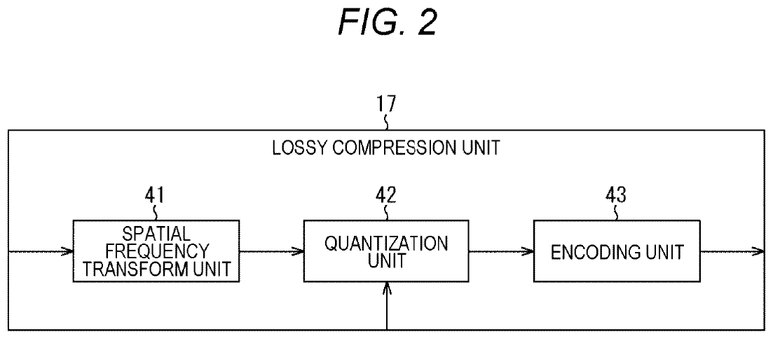

The lossy compression unit 17 (compression unit) performs lossy compression processing of performing wavelet compression on the captured image provided from the selection unit 12 to generate a RAW image on the basis of a compression ratio corresponding to the development size provided from the control unit 19. Details of the configuration of the lossy compression unit 17 will be described with reference to FIG. 2 to be described later. The lossy compression unit 17 provides the RAW image to the recording control unit 18.

The recording control unit 18 provides information indicating the development size provided from the control unit 19 to the recording medium 30 as recording size information indicating the development size set at the time of recording of the RAW image to record the information as a metadata file. In a case where the RAW image is not provided from the non-compression unit 15, the lossless compression unit 16, or the lossy compression unit 17, the recording control unit 18 provides the JPEG image provided from the YC codec 14 to the recording medium 30 to record the JPEG image as a JPEG file. The recording control unit 18 provides the RAW image provided from the non-compression unit 15 to the recording medium 30 to record the RAW image as an uncompressed RAW file.

The recording control unit 18 provides the RAW image provided from the lossless compression unit 16 to the recording medium 30 to record the RAW image as a lossless compressed RAW file. The recording control unit 18 provides the RAW image provided from the lossy compression unit 17 to the recording medium 30 to record the RAW image as a lossy compressed RAW file. At this time, the recording control unit 18 associates the metadata file with the lossy compressed RAW file.

In a case where the RAW image is provided from the non-compression unit 15, the lossless compression unit 16, or the lossy compression unit 17, the recording control unit 18 provides, as a thumbnail image, the JPEG image provided from the YC codec 14 to the recording medium 30 to record the JPEG image as a thumbnail file.

The thumbnail file is associated with the uncompressed RAW file, the lossless compressed RAW file, or the lossy compressed RAW file.

The control unit 19 controls each unit of the imaging device 10. For example, the control unit 19 (display control unit) controls the touch panel 21 to display various screens such as a recording setting screen for setting the presence or absence of RAW image recording, and a recording method setting screen for setting a recording method indicating a development size and a compression method.

The control unit 19 acquires, from touch panel 21, the recording method set by the user on the recording method setting screen. The control unit 19 provides, to the selection unit 12, a selection signal instructing selection from among the non-compression unit 15, the lossless compression unit 16, and the lossy compression unit 17 adapted to the compression method indicated by the recording method. In a case of providing a selection signal instructing selection of the lossless compression unit 16 to the selection unit 12, the control unit 19 provides the development size indicated by the recording method to the lossless compression unit 16. In a case of providing a selection signal instructing selection of the lossy compression unit 17 to the selection unit 12, the control unit 19 calculates a ratio of a development size to the development size indicated by the recording method. The control unit 19 reads the compression ratio corresponding to the ratio from the storage unit 20, provides the compression ratio to the lossy compression unit 17, and provides the development size to the recording control unit 18.

The storage unit 20 stores a compression ratio table in which the ratio of the development size to the capture size is associated with the compression ratio.

The storage unit 20 provides the compression ratio registered in the compression ratio table to the control unit 19 in accordance with the ratio of the development size to the capture size calculated by the control unit 19.

The touch panel 21 includes a display unit that performs display and an input unit that receives a touch operation performed on the display unit. The display unit of the touch panel 21 displays various screens provided from the control unit 19. The input unit of the touch panel 21 receives a user's operation performed on various screens displayed on the display unit and acquires information corresponding to the operation. For example, the input unit of the touch panel 21 (acquisition unit) receives a user's touch operation to set a recording method performed on the recording method setting screen and acquires the recording method. The input unit provides the recording method to the control unit 19.

The recording medium 30 includes a semiconductor memory, a memory card, or the like and is attachable to and detachable from the imaging device 10. The recording medium 30 records the RAW image provided from the recording control unit 18 as an uncompressed RAW file, a lossless compressed RAW file, or a lossy compressed RAW file. The recording medium 30 records the recording size information provided from the recording control unit 18 as a metadata file. This metadata file is associated with the lossy compressed RAW file. The recording medium 30 records the JPEG image provided from the recording control unit 18 as a JPEG file or a thumbnail file. The thumbnail file is associated with the uncompressed RAW file, the lossless compressed RAW file, or the lossy compressed RAW file.

### Configuration Example of Lossy Compression Unit

FIG. 2 is a block diagram illustrating a configuration example of the lossy compression unit 17 in FIG. 1.

The lossy compression unit 17 in FIG. 2 includes a spatial frequency transform unit 41, a quantization unit 42, and an encoding unit 43.

The spatial frequency transform unit 41 performs a wavelet transform on the captured image provided from the selection unit 12 in FIG. 1 to decompose the captured image into a plurality of spatial frequency components (resolution components). The spatial frequency transform unit 41 provides the spatial frequency components to the quantization unit 42.

The quantization unit 42 performs quantization for each spatial frequency component on the plurality of spatial frequency components provided from the spatial frequency transform unit 41 on the basis of the compression ratio provided from the control unit 19 in FIG. 1 to compress the captured image at the compression ratio. The quantization unit 42 provides the compressed captured image to the encoding unit 43.

The encoding unit 43 encodes the compressed captured image provided from the quantization unit 42 for each spatial frequency component to generate a RAW image. The encoding unit 43 provides the RAW image to the recording control unit 18 in FIG. 1.

### Example of Compression Ratio Table

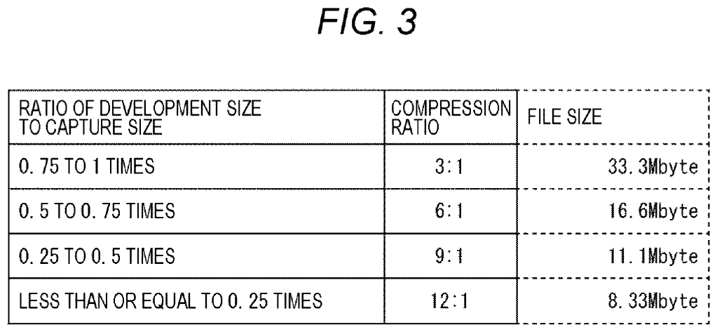

FIG. 3 is a diagram illustrating an example of the compression ratio table.

As indicated by the solid line table in FIG. 3, the compression ratio table is a table in which the ratio of the development size to the capture size is associated with the compression ratio. In the compression ratio table of FIG. 3, a compression ratio of “3:1” is registered in association with a case where the ratio of the development size to the capture size is “greater than 0.75 times and up to 1 time (full scale)”. In this case, as indicated by the dotted line table in FIG. 3, for example, the file size of the lossy compressed RAW file is 33.3 MB.

A compression ratio of “6:1” is registered in association with a case where the ratio of the development size to the capture size is “greater than 0.5 times and up to 0.75 times”. In this case, as indicated by the dotted line table in FIG. 3, for example, the file size of the lossy compressed RAW file is 16.6 MB.

A compression ratio of “9:1” is registered in association with a case where the ratio of the development size to the capture size is “greater than 0.25 times and up to 0.5 times”. In this case, as indicated by the dotted line table in FIG. 3, for example, the file size of the lossy compressed RAW file is 11.1 MB.

A compression ratio of “12:1” is registered in association with a case where the ratio of the development size to the capture size is “less than or equal to 0.25 times”. In this case, as indicated by the dotted line table in FIG. 3, for example, the file size of the RAW file is 8.33 MB.

As described above, in the imaging device 10, the smaller the ratio of the development size to the capture size set by the user, that is, the smaller the development size, the larger the compression ratio is set.

Specifically, since the wavelet compression is lossy compression, the larger the compression ratio of the RAW image, the more the image quality of the developed image deteriorates. However, the smaller the development size, the less noticeable the deterioration in the image quality of the developed image caused by the increase in the compression ratio. Therefore, the smaller the development size set by the user, the larger the compression ratio of the RAW image applied by the imaging device 10. It is therefore possible to reduce the data size of the RAW image while suppressing a deterioration in the image quality of the developed image.

### First Example of Recording Method Setting Screen

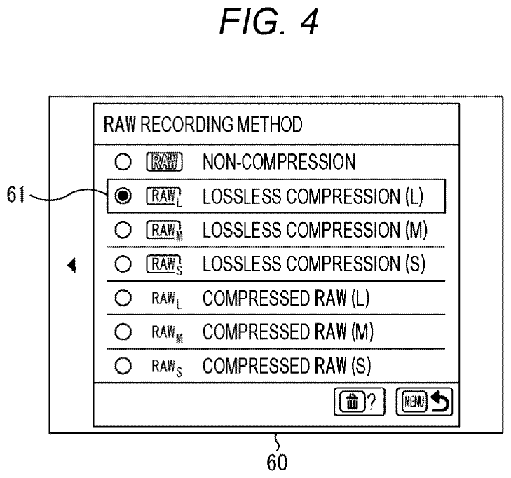

FIG. 4 is a diagram illustrating a first example of the recording method setting screen.

On a recording method setting screen 60 in FIG. 4, “non-compression”, “lossless compression (L) ”, “lossless compression (M)”, “lossless compression (S)”, “compressed RAW (L)”, “compressed RAW (M)”, and “compressed RAW(S)” are displayed as recording method information indicating the recording method of the RAW image.

“Non-compression” represents a recording method that indicates a compression method under which no compression is performed. “Lossless compression (L)” represents a recording method that indicates a lossless compression method as the compression method and the capture size as the development size. “Lossless compression (M)” represents a recording method that indicates a lossless compression method as the compression method and ½ times (50%) the capture size as the development size. “Lossless compression(S)” represents a recording method that indicates a lossless compression method as the compression method and ¼ times (25%) the capture size as the development size.

“Compressed RAW (L)” represents a recording method that indicates a lossy compression method as the compression method and the capture size as the development size. “Compressed RAW (M)” represents a recording method that indicates a lossy compression method as the compression method and ½ times (50%) the capture size as the development size. “Compressed RAW (S)” represents a recording method that indicates a lossy compression method as the compression method and ¼ times (25%) the capture size as the development size.

The user touches the display position of recording method information indicating a desired recording method in the recording method setting screen 60 displayed on the touch panel 21 to set the recording method. A cursor 61 is displayed in the recording method information indicating the recording method being set. In the example in FIG. 4, the user sets a recording method that indicates a lossless compression method as the compression method and the capture size as the development size, and the cursor 61 is displayed in the recording method information “lossless compression (L)” of the recording method.

As described above, on the recording method setting screen 60, three options, the same size as the capture size, ½ times the capture size, and ¼ times the capture size, are displayed as development size options in a case where the lossless compression method or the lossy compression method is set as the compression method. The user can set a desired development size from among the three options.

### Second Example of Recording Method Setting Screen

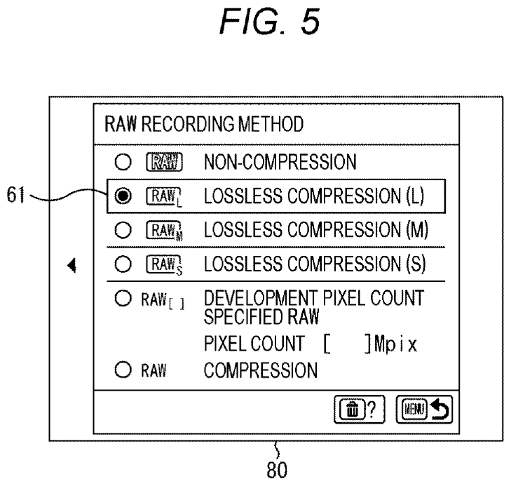

FIG. 5 is a diagram illustrating a second example of the recording method setting screen.

On a recording method setting screen 80 in FIG. 5, parts corresponding to those of the recording method setting screen 60 in FIG. 4 are denoted by the same reference numerals. Therefore, the description of the parts will be omitted as appropriate, and the following description will focus on part different from the recording method setting screen 60.

The recording method setting screen 80 is different from the recording method setting screen 60 in that “compression” is displayed as the recording method information instead of “compressed RAW (L)”, and “development pixel count specified RAW pixel count [] Mpix” is displayed instead of “compressed RAW (M)” and “compressed RAW (S)”, and the other parts are similar to those of the recording method setting screen 60.

“Compression” represents the recording method indicated by “compressed RAW (L)” on the recording method setting screen 60. “Development pixel count specified RAW pixel count [] Mpix” represents a recording method that indicates a lossy compression method as the compression method and a size input by the user as the development size. In a case where the user touches the display position of the recording method information “development pixel count specified RAW pixel count [] Mpix” to set the recording method indicated by the recording method information, the user inputs a pixel count as a desired development size through a touch operation or the like. As a result, the recording method indicates a lossy compression method as the compression method and a development size input by the user as the development size is set.

As described above, on the recording method setting screen 80, in a case where a lossy compression method is set as the compression method, any desired size can be set as the development size.

### Description of Setting Processing

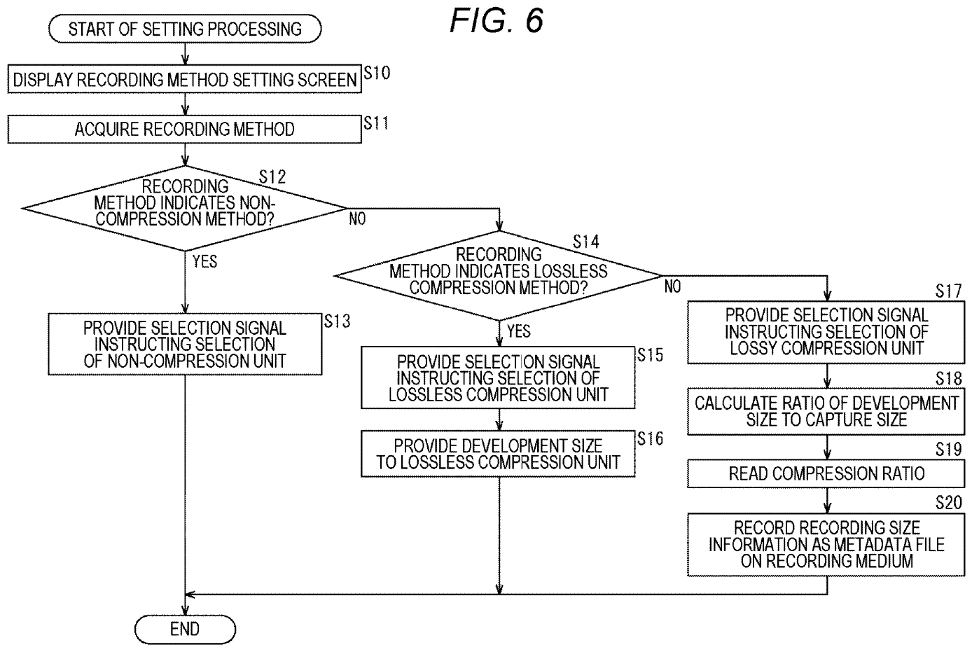

FIG. 6 is a flowchart for describing setting processing for setting a recording method by the imaging device 10 in FIG. 1. This setting processing begins in response to, for example, a command issued by the user to display the recording method setting screen 60 (80).

In step S10 in FIG. 6, the control unit 19 causes the display unit of the touch panel 21 to display the recording method setting screen 60 (80). The user touches the display position of recording method information indicating a desired recording method on recording method setting screen 60 (80) to set the recording method.

In step S11, the input unit of the touch panel 21 receives the touch operation, acquires the recording method set by the user, and provides the recording method to the control unit 19.

In step S12, the control unit 19 determines whether or not the recording method provided from the touch panel 21 indicates a non-compression method. In a case where it is determined in step S12 that the recording method indicates a non-compression method, the processing proceeds to step S13.

In step S13, the control unit 19 provides a selection signal instructing the selection of the non-compression unit 15 to the selection unit 12, and terminates the processing.

In a case where it is determined in step S12 that the recording method does not indicate a non-compression method, the processing proceeds to step S14. In step S14, the control unit 19 determines whether or not the recording method provided from the touch panel 21 indicates a lossless compression method.

In a case where it is determined in step S14 that the recording method indicates a lossless compression method, the processing proceeds to step S15. In step S15, the control unit 19 provides a selection signal instructing the selection of the lossless compression unit 16 to the selection unit 12.

In step S16, the control unit 19 provides the development size indicated by the recording method to the lossless compression unit 16, and terminates the processing.

On the other hand, in a case where it is determined in step S14 that the recording method does not indicate a lossless compression method, that is, in a case where the recording method indicates a lossy compression method, the processing proceeds to step S17. In step S17, the control unit 19 provides a selection signal instructing the selection of the lossy compression unit 17 to the selection unit 12.

In step S18, the control unit 19 calculates the ratio of the development size to the capture size on the basis of the development size indicated by the recording method. In step S19, the control unit 19 provides the ratio to the storage unit 20, and reads a compression ratio registered in the compression ratio table in association with the ratio. The control unit 19 provides the compression ratio to the lossy compression unit 17.

In step S20, the control unit 19 provides the development size indicated by the recording method to the recording control unit 18 and record, on the recording medium 30, recording size information indicating the development size as a metadata file. Then, the processing is brought to an end.

### Description of Lossy Compression Processing

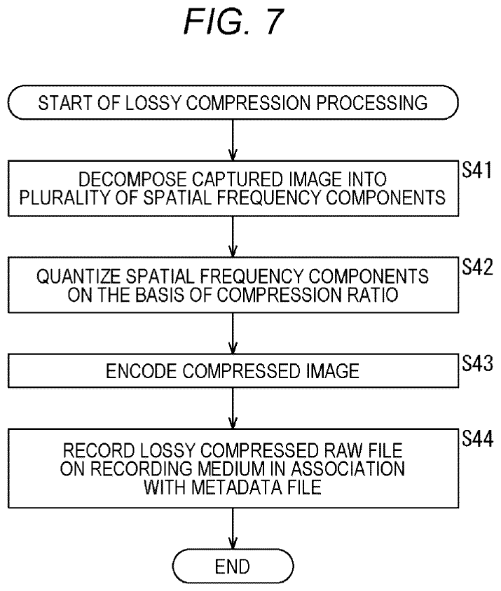

FIG. 7 is a flowchart for describing lossy compression processing by the lossy compression unit 17. This lossy compression processing begins when, for example, the captured image is provided from the selection unit 12 to the lossy compression unit 17 on the basis of the selection signal provided in the process of step S17 in FIG. 6.

In step S41 in FIG. 7, the spatial frequency transform unit 41 of the lossy compression unit 17 performs a wavelet transform on the captured image provided from the selection unit 12 to decompose the captured image into a plurality of spatial frequency components. The spatial frequency transform unit 41 provides the spatial frequency components to the quantization unit 42.

In step S42, the quantization unit 42 performs quantization on the plurality of spatial frequency components resulting from the decomposition in the process of step S41 on the basis of the compression ratio provided from the control unit 19 in the process of step S19 in FIG. 6 to obtain a captured image compressed at the compression ratio. The quantization unit 42 provides the compressed captured image to the encoding unit 43.

In step S43, the encoding unit 43 encodes the captured image compressed in the process of step S42 to generate a RAW image. The encoding unit 43 provides the RAW image to the recording control unit 18.

In step S44, the recording control unit 18 records, on the recording medium 30, the RAW image generated in the process of step S43 as a lossy compressed RAW file in association with the metadata file recorded in the process of step S20 in FIG. 6. Then, the processing is brought to an end.

### Configuration Example of Developing Device

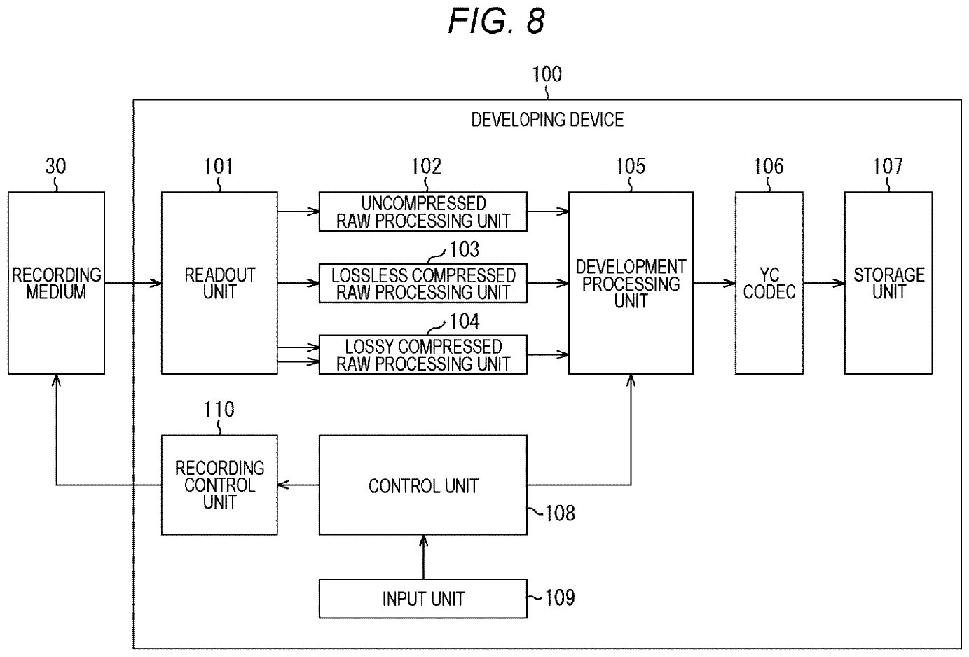

FIG. 8 is a block diagram illustrating a configuration example of an embodiment of a developing device as an image processing device to which the present technology is applied.

The developing device 100 in FIG. 8 includes a readout unit 101, an uncompressed RAW processing unit 102, a lossless compressed RAW processing unit 103, a lossy compressed RAW processing unit 104, a development processing unit 105, a YC codec 106, a storage unit 107, a control unit 108, an input unit 109, and a recording control unit 110.

The recording medium 30 on which an uncompressed RAW file, a lossless compressed RAW file, or a lossy compressed RAW file is recorded by the imaging device 10 is attachable to and detachable from the developing device 100. The developing device 100 reads the uncompressed RAW file, the lossless compressed RAW file, or the lossy compressed RAW file recorded on the attached recording medium 30 and develops and stores the RAW image.

Specifically, the readout unit 101 reads the RAW image recorded as the uncompressed RAW file from the recording medium 30, and provides the RAW image to the uncompressed RAW processing unit 102. The readout unit 101 reads the RAW image recorded as the lossless compressed RAW file from the recording medium 30, and provides the RAW image to the lossless compressed RAW processing unit 103. The readout unit 101 reads the RAW image recorded as the lossy compressed RAW file from the recording medium 30, and provides the RAW image to the lossy compressed RAW processing unit 104.

The readout unit 101 reads and acquires the metadata file recorded in association with the lossy compressed RAW file from the recording medium 30. The readout unit 101 provides the recording size information included in the metadata file or post-recording size information indicating a development size set after recording of the lossy compressed RAW file to the lossy compressed RAW processing unit 104.

The uncompressed RAW processing unit 102 performs uncompressed RAW processing to decode and inverse-quantize the RAW image provided from the readout unit 101 to generate a Bayer image with the capture size. The uncompressed RAW processing unit 102 provides the Bayer image to the development processing unit 105.

The lossless compressed RAW processing unit 103 performs lossless compressed RAW processing to generate a Bayer image with the development size set at the time of recording by decompressing the RAW image provided from the readout unit 101 in accordance with the lossless compression method. The lossless compressed RAW processing unit 103 provides the Bayer image to the development processing unit 105.

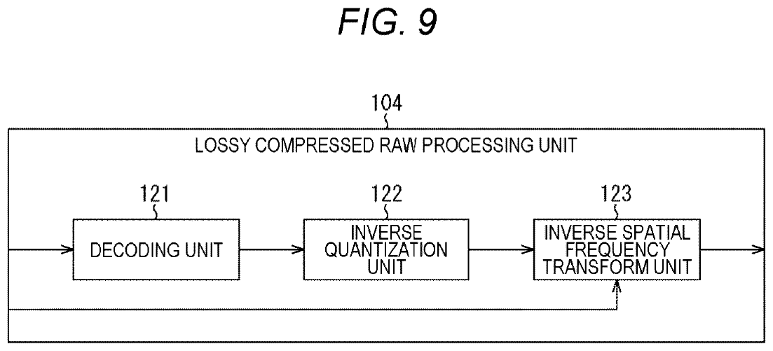

The RAW image, and the recording size information or the post-recording size information are provided from the readout unit 101 to the lossy compressed RAW processing unit 104. The lossy compressed RAW processing unit 104 performs, on the basis of the development size indicated by the recording size information or the post-recording size information, lossy compressed RAW processing to generate a Bayer image with the development size by, for example, decompressing the RAW image corresponding to the wavelet compression. Details of the configuration of the lossy compressed RAW processing unit 104 will be described with reference to FIG. 9 to be described later. The lossy compressed RAW processing unit 104 provides the Bayer image to the development processing unit 105. Note that the lossy compressed RAW processing unit 104 may generate an RGB image, rather than the Bayer image.

The development processing unit 105 performs development processing on the Bayer image provided from the uncompressed RAW processing unit 102, the lossless compressed RAW processing unit 103, or the lossy compressed RAW processing unit 104 to generate a developed image, which is a YCbCr image. At this time, in a case where the development size is provided from the control unit 108, the development processing unit 105 performs downscaling processing to generate a developed image with the development size. This downscaling processing is performed in the domain of the RGB image, rather than the Bayer image. As a result, the image quality of the developed image with the development size can be improved. The development processing unit 105 provides the developed image thus generated to the YC codec 106.

The YC codec 106 performs quantization and JPEG encoding on the developed image provided from the development processing unit 105 to generate a JPEG image. The YC codec 106 provides the JPEG image to the storage unit 107 for storage.

The storage unit 107 stores the JPEG image provided from the YC codec 106.

The control unit 108 controls each unit. For example, the control unit 108 provides, to the development processing unit 105, the development size for the RAW image of the uncompressed RAW file or the lossless compressed RAW file provided from the input unit 109. The control unit 108 provides, to the recording control unit 110, information indicating the development size for the RAW image of the lossy compressed RAW file provided from the input unit 109 as post-recording development size information.

The input unit 109 receives input of the development size for the RAW image of the uncompressed RAW file, the lossless compressed RAW file, or the lossy compressed RAW file input by the user and provides the development size to the control unit 108.

The recording control unit 110 provides the post-recording development size information provided from the control unit 108 to the recording medium 30 to record the post-recording development size information in the metadata file recorded on the recording medium 30. At this time, in a case where the post-recording development size information is already included in the metadata file, the recording control unit 110 updates the post-recording development size information to new post-recording development size information provided from the control unit 108. The post-recording development size information is read and acquired by the readout unit 101.

Note that, in the developing device 100, the JPEG image is stored in the built-in storage unit 107, but may be recorded on the recording medium 30. The recording medium 30 may be built in the imaging device 10. In this case, the imaging device 10 and the developing device 100 are connected by a cable or the like, enabling the developing device 100 to read various files from the recording medium 30.

### Configuration Example of Lossy Compressed RAW Processing Unit

FIG. 9 is a block diagram illustrating a configuration example of the lossy compressed RAW processing unit 104 in FIG. 8.

The lossy compressed RAW processing unit 104 in FIG. 9 includes a decoding unit 121, an inverse quantization unit 122, and an inverse spatial frequency transform unit 123.

The decoding unit 121 of the lossy compressed RAW processing unit 104 decodes the RAW image provided from the readout unit 101 in FIG. 8 and provides the decoded RAW image to the inverse quantization unit 122.

The inverse quantization unit 122 performs inverse quantization (re-quantization) on the RAW image provided from the decoding unit 121. The inverse quantization unit 122 provides the inverse-quantized RAW image to the inverse spatial frequency transform unit 123.

The inverse spatial frequency transform unit 123 performs an inverse spatial frequency transform on the RAW image provided from the inverse quantization unit 122 to decompress the RAW image on the basis of the development size indicated by the recording size information or the post-recording size information provided from the readout unit 101. Specifically, the inverse spatial frequency transform unit 123 performs the inverse spatial frequency transform on predetermined spatial frequency components corresponding to the development size among the plurality of spatial frequency components as the inverse-quantized RAW image to generate a Bayer image with the development size. The inverse spatial frequency transform unit 123 provides the Bayer image to the development processing unit 105 in FIG. 1. Note that, since extractable Bayer image sizes are discrete, the inverse spatial frequency transform unit 123 may generate a Bayer image with a size necessary for generating a developed image with the development size rather than generating a Bayer image with the development size, and the development processing unit 105 may downscale the Bayer image to the development size during the development processing. For example, in a case where the capture size is 50 MP and the development size is 10 MP, the inverse spatial frequency transform unit 123 may generate a 12.5-MP Bayer image that is easy to extract, and the development processing unit 105 may generate a developed image downscaled to 10 MP.

### Relationship Between Recording Method and the Presence or Absence of Downscaling at the Time of Recording and Development of RAW Image>

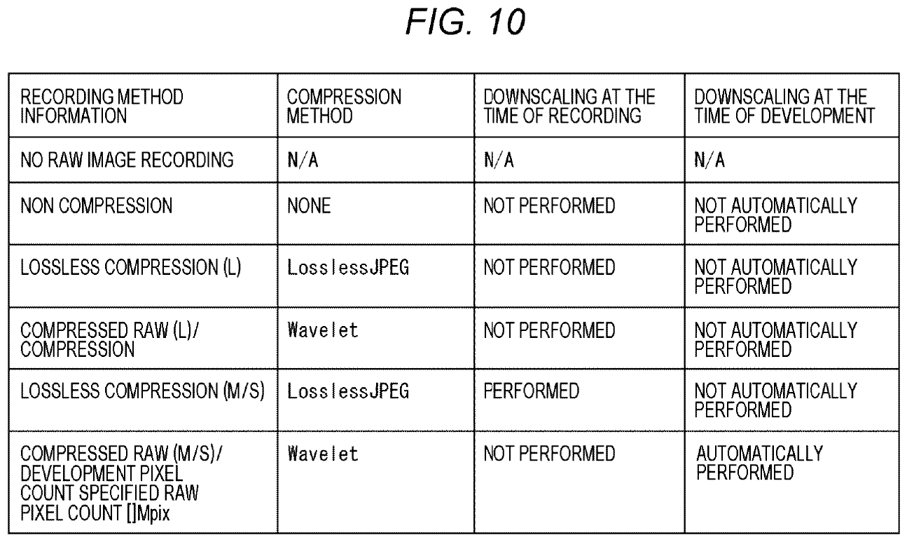

FIG. 10 is a diagram showing a relationship between a RAW image recording method and the presence or absence of downscaling at the time of recording and development.

In the table in FIG. 10, except for the first row, information indicating the RAW image compression method, the presence or absence of downscaling at the time of recording of the RAW image, and the presence or absence of downscaling at the time of development of the RAW image in a case where the recording method indicated by the recording method information is set is described in association with the recording method information.

In the first row of the table in FIG. 10, information indicating the RAW image compression method, the presence or absence of downscaling at the time of recording of the RAW image, and the presence or absence of downscaling at the time of development of the RAW image in a case of “no RAW image recording” is described in association with “no RAW image recording” instead of the recording method information. “No RAW image recording” indicates a case where the user sets no RAW image recording on the recording setting screen. In this case, since no RAW image is recorded, “not applicable” (N/A) is described as the information indicating the RAW image compression method, the presence or absence of downscaling at the time of recording of the RAW image, and the presence or absence of downscaling at the time of development of the RAW image.

As shown in the second row of the table in FIG. 10, in a case where the recording method indicated by the recording method information “non compression” is set, the RAW image compression method is a method under which no compression is performed, and the image size is not reduced at the time of recording of the RAW image. In this case, the image size is not reduced at the time of development either unless instructed by the user.

As shown in the third row of the table in FIG. 10, in a case where the recording method indicated by the recording method information “lossless compression (L)” is set, the RAW image compression method is, for example, a Lossless JPEG method, and the image size is not reduced at the time of recording of the RAW image. In this case, the image size is not reduced at the time of development either unless instructed by the user.

As shown in the fourth row of the table in FIG. 10, in a case where the recording method indicated by the recording method information “compression (L)” or “compression” is set, the RAW image compression method is, for example, a method using a wavelet transform, and the image size is not reduced at the time of recording of the RAW image. In this case, the image size is not reduced at the time of development either unless instructed by the user.

As shown in the fifth row of the table in FIG. 10, in a case where the recording method indicated by the recording method information “lossless compression (M)” or “lossless compression (S)” is set, the RAW image compression method is, for example, a Lossless JPEG method, and the image size is reduced at the time of recording of the RAW image. In this case, the image size is not reduced at the time of development either unless instructed by the user.

As shown in the sixth row of the table in FIG. 10, in a case where the recording method indicated by the recording method information “compressed RAW (M)”, “compressed RAW (S)”, or “development pixel count specified RAW pixel count [] Mpix” is set, the RAW image compression method is, for example, a method using a wavelet transform. In this case, the image size is not reduced at the time of recording of the RAW image, but the image size is reduced at the time of development on the basis of the recording size information or the post-recording size information.

### Description of Processing of Imaging and Developing Devices

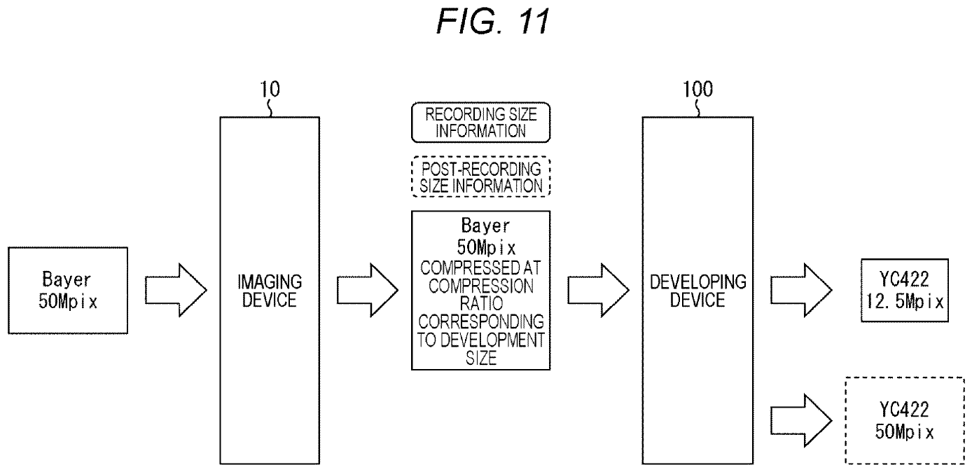

FIG. 11 is a diagram illustrating processing of the imaging device 10 and the developing device 100 in a case where the recording method indicated by the recording method information “compressed RAW (S)” is set.

The user sets the recording method indicated by the recording method information “compressed RAW (S)” to the imaging device 10 at the time of recording of the RAW image. As illustrated in FIG. 11, in a case where the captured image is a Bayer image of 50 MP, the imaging device 10 compresses the captured image with wavelet compression at a compression ratio corresponding to 0.25 times as a ratio of the development size indicated by the recording method to the capture size. Then, the imaging device 10 generates a wavelet-compressed Bayer image of 50 MP as a RAW image. The imaging device 10 records the RAW image on the recording medium 30 as a lossy compressed RAW file. The imaging device 10 records, on the recording medium 30, recording size information indicating 12.5 MP (=50×0.25) that is a development size indicated by the recording method as a metadata file in association with the lossy compressed RAW file.

In a case where the user does not set a new development size after recording of the RAW image, the developing device 100 reads the RAW image and the recording size information from the recording medium 30. The developing device 100 develops the RAW image at a reduced size that is 12.5 MP indicated by the recording size information to generate a YCbCr image such as YC422 of 12.5 MP as a developed image.

On the other hand, in a case where the user sets a new development size to the developing device 100 after recording of the RAW image, the developing device 100 records, on the recording medium 30, recording size information indicating the development size with the recording size information included in the metadata file corresponding to the RAW image. In a case where a new development size is set a plurality of times after recording of the RAW image, the recording size information is updated every time the new development size is set, and recording size information indicating the latest development size is finally recorded on the recording medium 30. The developing device 100 reads the RAW image and the post-recording size information from the recording medium 30.

For example, in a case where the post-recording size information indicates 50 MP, the developing device 100 develops the RAW image at full scale to generate a YCbCr image such as YC 422 of 50 MP as a developed image. As described above, since the image size of the RAW image is the capture size, the development size can be changed to the capture size at the time of development.

### Example of Overview of Processing of Other Imaging and Developing Devices

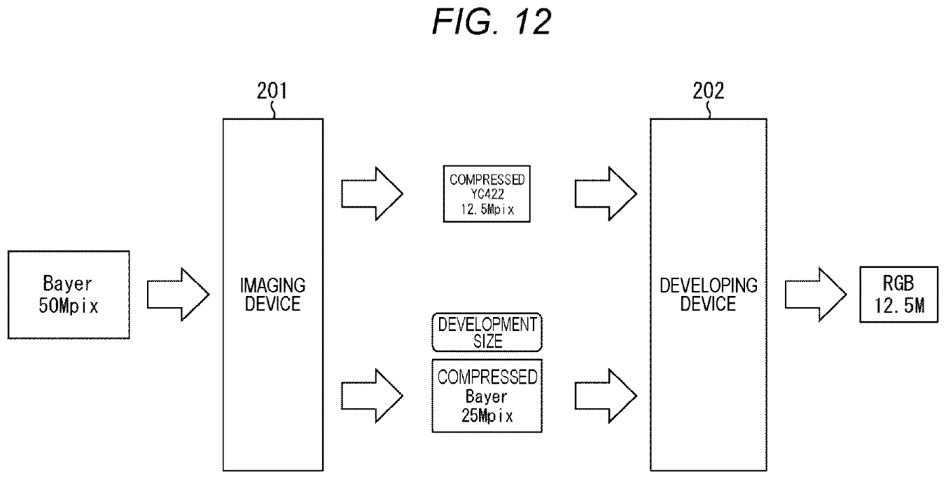

FIG. 12 is a diagram illustrating an example of processing of an imaging device that generates a RAW image by compressing a captured image with a development size smaller than a capture size by a lossless compression method, and a developing device that generates a developed image from the RAW image.

The user sets the development size to an imaging device 201. In the example in FIG. 12, the development size is 0.25 times the capture size. As illustrated in FIG. 12, in a case where the captured image is a Bayer image of 50 MP, the imaging device 201 converts the captured image into a YCbCr image of YC422, reduces the capture size to the development size, and compresses the image by a lossless compression method. The imaging device 201 records the resulting compressed YCbCr image of 12.5 MP (=50×0.25) as a RAW image. As described above, since the imaging device 201 generates the RAW image by converting the captured image into the YCbCr image of YC422, it is possible to suppress a decrease in luminance resolution of the RAW image. A developing device 202 develops the RAW image without changing the image size to generate an RGB image of 12.5 MP as a developed image.

Note that the imaging device 201 may generate the RAW image by reducing the image size to an intermediate size larger than the development size and smaller than the capture size and compressing the captured image by a lossless compression method, without converting the captured image into the YCbCr image. In this case, as illustrated in FIG. 12, the imaging device 201 generates a RAW image that is a Bayer image of 25 MP (=50×0.5), for example, by downscaling the captured image that is a Bayer image of 50 MP to 0.5 times the capture size that is the intermediate size and compressing the same by a lossless compression method. The imaging device 201 records the RAW image and 12.5 MP as the development size in association with each other on the recording medium.

The developing device 202 develops the RAW image recorded on the recording medium at a reduced size of 12.5 MP that is the development size associated with the RAW image to generate an RGB image of 12.5 MP as a developed image.

### Example of Overview of Processing of Still Other Imaging and Developing Devices

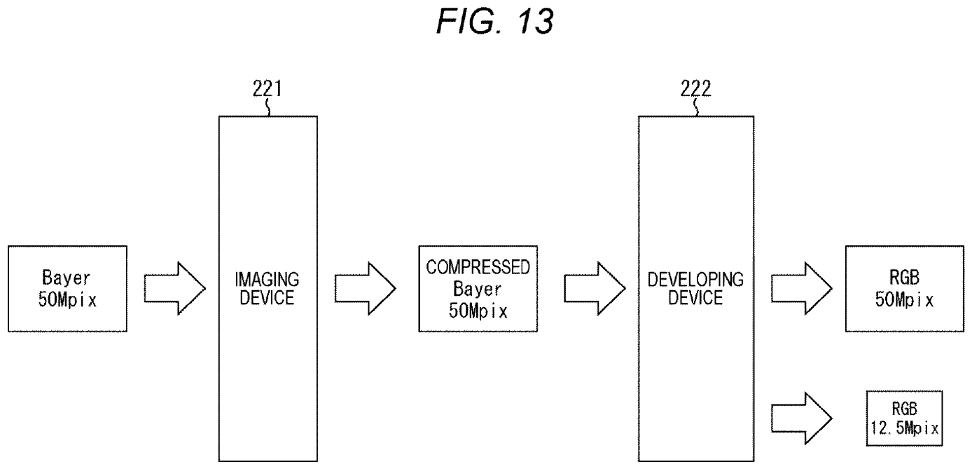

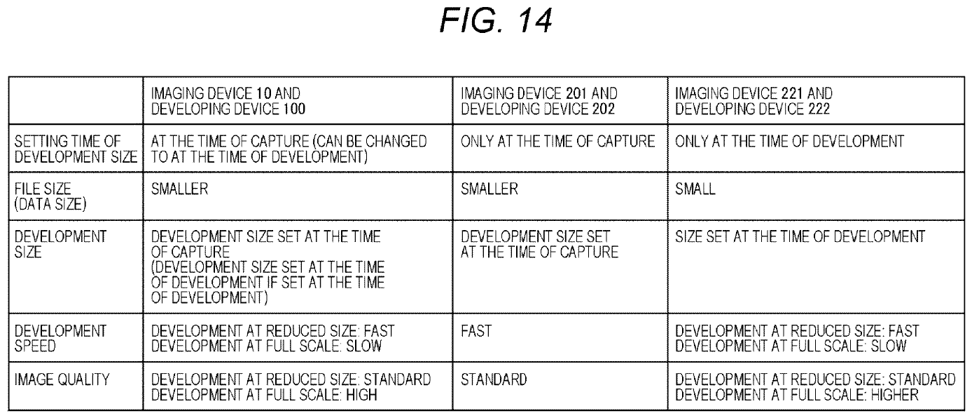

FIG. 13 is a diagram illustrating an example of an overview of processing of an imaging device that generates a RAW image by compressing a captured image with wavelet compression and a developing device that develops the RAW image, without a setting function for development size.

As illustrated in FIG. 13, in a case where the captured image is a Bayer image of 50 MP, an imaging device 221 compresses the captured image with wavelet compression at a predetermined compression ratio, for example. This compression ratio may be preset or may be selected by the user. For example, the compression ratio is within a range from 3:1 to 5:1 in a case where the captured image is a moving image, and is about 4:1 in a case where the captured image is a still image. The imaging device 221 records the wavelet-compressed Bayer image of 50 MP as a RAW image.

In a case where the user does not set the development size to a developing device 222, the developing device 202 develops the RAW image at full scale to generate an RGB image of 50 MP as a developed image. On the other hand, in a case where the RAW image is developed at a reduced size, the user sets the development size to the developing device 222. In a case where 12.5 MP is set as the development size by the user, the developing device 202 develops the RAW image at a reduced size of 12.5 MP to generate an RGB image of 12.5 MP as a developed image.

### Description of Effects of Present Technology

FIG. 14 is a diagram for comparing the processing and processing results of FIGS. 11 to 13.

As shown in the table in FIG. 14, in the processing of the imaging device 10 and the development processing 100, the development size is set at the time of capture, that is, at the time of recording of the RAW image. The development size can be changed after recording of the RAW image such as at the time of development.

On the other hand, in the imaging device 201 and the developing device 202 in FIG. 12, the development size can be set only at the time of capture, that is, at the time of recording of the RAW image. On the other hand, in the imaging device 221 and the developing device 222 in FIG. 13, the development size can be set only at the time of development of the RAW image.

In a case where the development size set at the time of capture is smaller than the capture size, the file size (data size) of the lossy compressed RAW file generated by the processing of the imaging device 10 is smaller than the file size of the RAW file generated by the processing of the imaging device 221.

Specifically, since the wavelet compression is lossy compression, the larger the compression ratio of the wavelet compression, the more the image quality of the developed image deteriorates. However, the smaller the development size, the less noticeable the deterioration in the image quality of the developed image. Therefore, the imaging device 10 performs compression such that the compression ratio increases as the development size set by the user decreases, thereby reducing the file size while suppressing a deterioration in the image quality of the developed image.

On the other hand, since the imaging device 221 does not have a setting function for development size, the imaging device 221 compresses the captured image with wavelet compression at a predetermined compression ratio, regardless of the development size. Therefore, the imaging device 221 needs to set the compression ratio smaller in consideration of the image quality in a case where the development size is the capture size, that is, in a case where the deterioration in the image quality of the developed image due to an increase in the compression ratio is most noticeable. Therefore, the file size of the RAW image generated by the imaging device 221 is larger than the file size of the lossy compressed RAW file generated by the imaging device 10.

The imaging device 201 generates a RAW image with a development size smaller than the capture size.

Therefore, the file size of the RAW image generated by the imaging device 201 is larger than the file size of the RAW file generated by the processing of the imaging device 221.

As described above, regarding the file size of the RAW image, the imaging device 10 and the imaging device 201 are superior to the imaging device 221.

The development size of the developed image generated by the processing of the developing device 100 is automatically set to a development size that is set at the time of capture and is smaller than or equal to the capture size. Note that, in a case where a new development size is set after recording of the RAW image such as at the time of development, the development size of the developed image is set to the newly set development size.

The development size of the developed image generated by the processing of the developing device 202 is a development size that is set at the time of capture and is smaller than the capture size. The development size of the developed image generated by the processing of the developing device 222 is a development size that is set at the time of development and is smaller than or equal to the capture size.

As described above, the developing device 100 and the developing device 222 are superior to the developing device 202 in that the development size of the developed image can be set at the time of development. The developing device 100 is further superior to the developing device 222 in that it is not necessary to perform setting at the time of development even at the time of development at a reduced size.

Since the developing device 100 performs so-called hierarchical decoding in which only the spatial frequency components of the RAW image necessary for generating the developed image with the development size are subjected to an inverse spatial frequency transform at the time of development at a reduced size, the processing load can be reduced as compared with development at full scale.

Therefore, the generation speed of the developed image at the time of development at a reduced size is fast. On the other hand, at the time of development at full scale, it is necessary to perform an inverse spatial frequency transform on all the spatial frequency components of the RAW image, which makes the generation speed of the developed image slow. The same applies to the generation speed of the developed image by the developing device 222. Since the developing device 202 develops the RAW image with the development size smaller than the capture size, the generation speed of the developed image by the developing device 202 is fast.

Since the deterioration in the image quality of the developed image generated by the processing of the developing device 100 due to a large compression ratio is not noticeable in a case of development at a reduced size, the image quality is a standard level similar to the image quality of the developed image generated by the developing device 202. The image quality of the developed image generated by the developing device 222 is a standard level similar to the image quality of the developed image generated by the processing of the developing device 100 in a case of development at a reduced size.

In a case where the development size set at the time of capture is smaller than the capture size, the compression ratio in the imaging device 100 is larger than the compression ratio in the imaging device 221.

Therefore, in a case of development at full scale, the image quality of the developed image generated by the processing of the developing device 222 is higher than the image quality of the developed image generated by the processing of the developing device 100.

As described above, in the imaging device 10, in a case where the user develops the RAW image at a reduced size, a development size smaller than the capture size is set at the time of capture. Therefore, there is an advantage that the imaging device 100 can reduce the file size of the RAW image while suppressing a deterioration in the image quality of the developed image as compared with the imaging device 221 by performing wavelet compression at the compression ratio corresponding to the development size. Note that, in a case where the user changes the development size to a larger development size at the time of development of the RAW image, for example, in a case where the RAW image is developed at full scale, there is a possibility that the image quality of the developed image generated by the processing of the developing device 100 deteriorates as compared with the developed image generated by the processing of the developing device 222. In the developing device 100, even in a case where the RAW image is developed at a reduced size, there is an advantage that the user need not specify the development size at the time of development.

On the other hand, the imaging device 201 reduces the image size to the development size at the time of recording of the RAW image. Therefore, there is a disadvantage that the developing device 202 cannot generate a developed image with a development size larger than the development size set at the time of recording of the RAW image. That is, there is a disadvantage that the developing device 222 cannot develop the RAW image at full scale, for example.

Since the imaging device 221 does not have a setting function for development size, there is a disadvantage that the file size of the RAW image cannot be reduced even in a case where the RAW image is developed at a reduced size. In the developing device 222, in a case where the RAW image is developed at a reduced size, there is a disadvantage that the user needs to set the development size at the time of development.

### Description of Processing of Developing Device

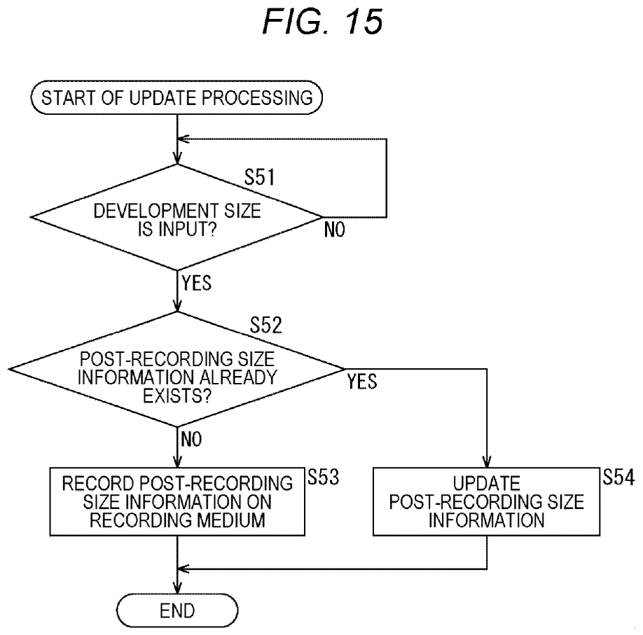

FIG. 15 is a flowchart for describing update processing of updating the development size of the developing device 100. This update processing is performed when an uncompressed RAW file for updating the development size is selected, for example.

In step S51 in FIG. 15, the input unit 109 of the developing device 100 determines whether or not the user has input the development size. In a case where it is determined in step S51 that the development size has not been input, the input unit 109 waits for the input.

On the other hand, in a case where it is determined in step S51 that the development size has been input, the input unit 109 provides the development size to the control unit 108, and the processing proceeds to step S52. In step S52, the control unit 108 determines whether or not the post-recording size information already exists in the metadata file corresponding to the uncompressed RAW file being selected.

In a case where it is determined in step S52 that the post-recording size information does not already exist, the processing proceeds to step S53. In step S53, the control unit 108 records, on the recording medium 30, information indicating the development size provided from the input unit 109 with the information included in the metadata file corresponding to the uncompressed RAW file being selected as the post-recording size information. Then, the processing is brought to an end.

In a case where it is determined in step S52 that the post-recording size information already exists, the processing proceeds to step S54. In step S54, the control unit 108 updates the post-recording size information included in the metadata file corresponding to the uncompressed RAW file being selected recorded on the recording medium 30, using the information indicating the development size provided from the input unit 109 as the post-recording size information. Then, the processing is brought to an end.

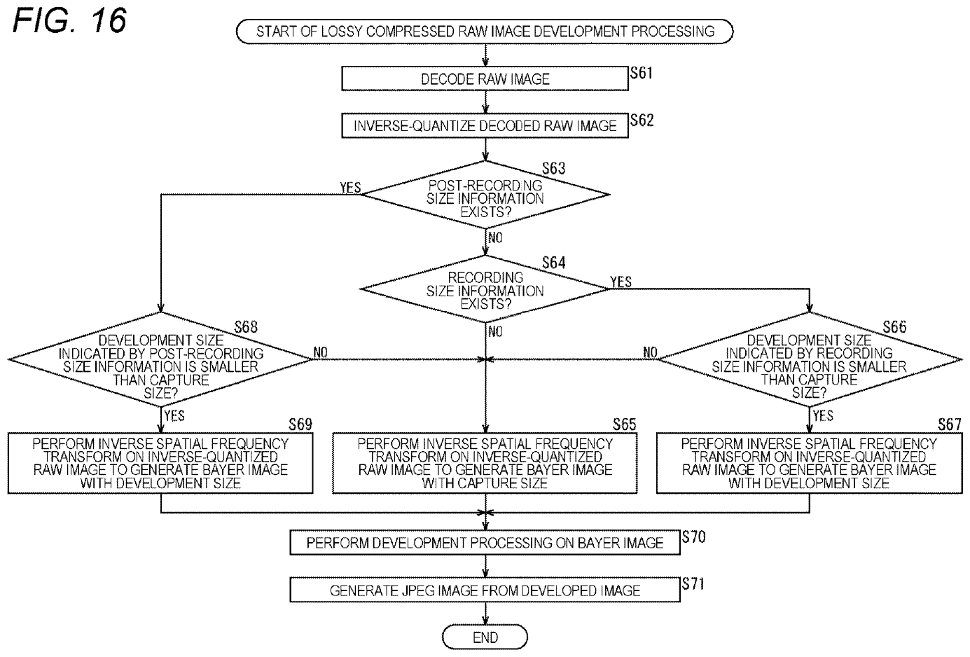

FIG. 16 is a flowchart for describing lossy compressed RAW development processing of developing a lossy compressed RAW file by the developing device 100. This lossy compressed RAW development processing begins, for example, when a RAW image recorded as a lossy compressed RAW file on the recording medium 30 is read by the readout unit 101 as a development target and provided to the lossy compressed RAW processing unit 104.

In step S61 in FIG. 16, the decoding unit 121 of the lossy compressed RAW processing unit 104 decodes the RAW image provided from the readout unit 101 and provides the decoded RAW image to the inverse quantization unit 122.

In step S62, the inverse quantization unit 122 inversely quantizes the decoded RAW image obtained by the process of step S61. The inverse quantization unit 122 provides the inverse-quantized RAW image to the inverse spatial frequency transform unit 123.

In step S63, the readout unit 101 determines whether or not the post-recording size information exists in the metadata file corresponding to the lossy compressed RAW file to be developed recorded on the recording medium 30.

In a case where it is determined in step S63 that the post-recording size information does not exist, the processing proceeds to step S64. In step S64, the readout unit 101 determines whether or not the recording size information exists in the metadata file corresponding to the lossy compressed RAW file to be developed recorded on the recording medium 30.

In a case where it is determined in step S64 that the recording size information does not exist, the processing proceeds to step S65. For example, in a case where the development target is a lossy compressed RAW file generated by an imaging device other than the imaging device 10, and the metadata file including the recording size information is not recorded in association with the lossy compressed RAW file, the processing proceeds to step S65.

In step S65, the inverse spatial frequency transform unit 123 performs an inverse spatial frequency transform on all the plurality of spatial frequency components as the inverse-quantized RAW image obtained by the process of step S62 to generate a Bayer image with the capture size. Then, the inverse spatial frequency transform unit 123 provides the Bayer image to the development processing unit 105, and the processing proceeds to step S70.

On the other hand, in a case where it is determined in step S64 that the recording size information exists, the readout unit 101 reads the recording size information from the recording medium 30 and provides the recording size information to the inverse spatial frequency transform unit 123, and the processing proceeds to step S66. In step S66, the inverse spatial frequency transform unit 123 determines whether or not the development size indicated by the recording size information is smaller than the capture size.

In a case where it is determined in step S66 that the development size indicated by the recording size information is not smaller than the capture size, that is, in a case where it is determined that the development size is equal to the capture size, the processing proceeds to step S65. As a result, as described above, a Bayer image with the capture size is generated and provided to the development processing unit 105, and the processing proceeds to step S70.

On the other hand, in a case where it is determined in step S66 that the development size indicated by the recording size information is smaller than the capture size, the processing proceeds to step S67. In step S67, the inverse spatial frequency transform unit 123 performs an inverse spatial frequency transform only on predetermined spatial frequency components corresponding to the development size among the plurality of spatial frequency components as the inverse-quantized RAW image obtained by the process of step S62 to generate a Bayer image with the development size. Then, the inverse spatial frequency transform unit 123 provides the Bayer image to the development processing unit 105, and the processing proceeds to step S70.

On the other hand, in a case where it is determined in step S63 that the post-recording size information exists, the readout unit 101 reads the post-recording size information from the recording medium 30 and provides the post-recording size information to the inverse spatial frequency transform unit 123, and the processing proceeds to step S68.

In step S68, the inverse spatial frequency transform unit 123 determines whether or not the development size indicated by the post-recording size information is smaller than the capture size. In a case where it is determined in step S68 that the development size indicated by the post-recording size information is not smaller than the capture size, that is, in a case where it is determined that the development size is equal to the capture size, the processing proceeds to step S65. As a result, as described above, a Bayer image with the capture size is generated and provided to the development processing unit 105, and the processing proceeds to step S70.

On the other hand, in a case where it is determined in step S68 that the development size indicated by the post-recording size information is smaller than the capture size, the processing proceeds to step S69. In step S69, the inverse spatial frequency transform unit 123 performs an inverse spatial frequency transform on predetermined spatial frequency components corresponding to the development size among the plurality of spatial frequency components as the inverse-quantized RAW image obtained in step S62 to generate a Bayer image with the development size. Then, the inverse spatial frequency transform unit 123 provides the Bayer image to the development processing unit 105, and the processing proceeds to step S70.

In step S70, the development processing unit 105 performs development processing on the Bayer image generated by the process of step S65, S67, or S69 to generate a developed image that is a YCbCr image. The development processing unit 105 provides the resulting developed image to the YC codec 106.

In step S71, the YC codec 106 performs quantization and JPEG encoding on the developed image generated in step S70 to generate a JPEG image. The YC codec 106 provides the JPEG image to the storage unit 107 for storage. Then, the processing is brought to an end.

Note that the processes of steps S61 and S62 described above may be performed immediately before the processes of steps S65, S67, and S69. In this case, for example, the decoding unit 121 and the inverse quantization unit 122 decodes and inverse-quantizes only the spatial frequency components of the RAW image corresponding to the development size. With this configuration, it is possible to increase the processing speed of decoding and inverse quantization at the time of development at a reduced size.

As described above, the imaging device 10 acquires the development size and generates a RAW image by performing wavelet compression on the captured image at a compression ratio that is set to increase as the development size decreases. As a result, in a case where the development size is smaller than the capture size, the imaging device 10 can generate a RAW image smaller in data size than a RAW image generated by the imaging device 221 without a setting function for development size. In a case where the compression ratio is large, the image quality of the developed image deteriorates, but in a case where the development size is small, the deterioration is less noticeable. It is therefore possible for the imaging device 10 to reduce the data size of the RAW image while suppressing a deterioration in image quality of the developed image. As a result, the user can capture more images more smoothly using the imaging device 10.

In the imaging device 10, since the user can set the development size at the time of capture, it is not necessary to set the development size at the time of development. Therefore, the user's workload is reduced in the development process. As a result, the development time can be saved.

The metadata file can include both the recording size information and the post-recording size information. That is, the information indicating the development size can be redundantly held in the metadata file. Therefore, the user can change the development size at the time of development. It is therefore possible to develop, at full scale, a RAW image intended at the time of capture to be developed at a reduced size. As a result, even in a case where an incorrect development size is set at the time of capture, a case where the RAW image is used for a purpose other than the intended use at the time of capture, or the like, the RAW image can be developed at a desired development size. Therefore, user convenience is improved.

Note that, in the present embodiment, in a case where the compression method indicates a lossless compression method and the development size indicates an image size smaller than the capture size, downscaling is not performed at the time of capture unless instructed by the user, but the captured image may be downscaled to an intermediate size at the time of recording of the RAW image, and the RAW image may be further downscaled to the development size at the time of development. In this case, the metadata file including the information indicating the development size set at the time of recording of the lossless compressed RAW file is recorded on the recording medium 30 in association with the lossless compressed RAW file. Then, after the lossless compression processing, the lossless compressed RAW processing unit 103 reduces the image size of the Bayer image to the development size indicated by the information included in the metadata file.

In the present embodiment, the post-recording development size information is recorded in the developing device 100, but may be recorded in the imaging device 10.

In the present embodiment, the development processing is processing of converting the Bayer image into the YCbCr image, but may be processing of converting the Bayer image into the RGB image. The imaging device 10 and the developing device 100 may be combined in one device. The compression method in the lossy compression unit 17 may be a compression method other than the compression method using a wavelet transform, such as a compression method using the discrete cosine transform (DCT), as long as the compression method compresses the captured image by decomposing the captured image into a plurality of spatial frequencies.

### Computer

### Configuration Example of Computer

The above-described series of processes can be executed by hardware or software. In a case where the series of processes is executed by software, a program that configures the software is installed in a computer. Here, examples of the computer include a computer incorporated in dedicated hardware, a general-purpose personal computer that can execute various functions by being installed with various programs, and the like.

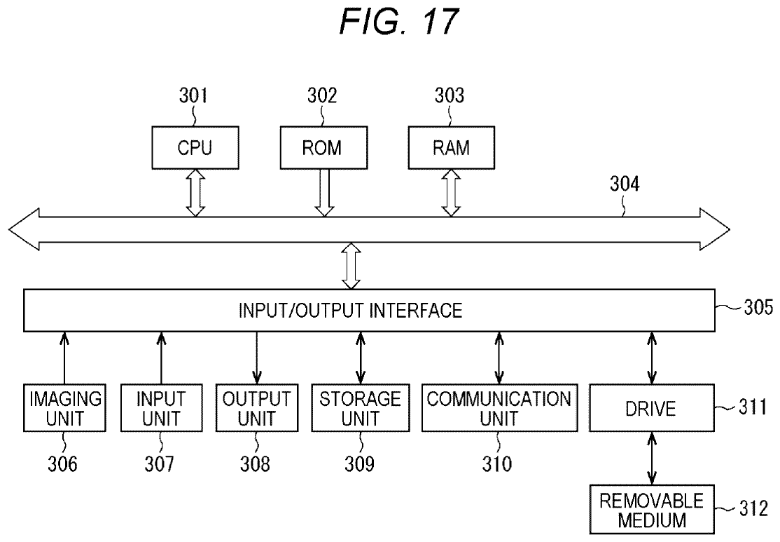

FIG. 17 is a block diagram illustrating a configuration example of hardware of the computer that executes the above-described series of processes in accordance with a program.

In a computer, a central processing unit (CPU) 301, a read only memory (ROM) 302, and a random access memory (RAM) 303 are mutually connected by a bus 304.

The bus 304 is further connected with an input/output interface 305. The input/output interface 305 is connected with an imaging unit 306, an input unit 307, an output unit 308, a storage unit 309, a communication unit 310, and a drive 311.

The imaging unit 306 includes the image sensor 11 and the like. The input unit 307 includes a keyboard, a mouse, a microphone, an input unit of a touch panel, or the like. The output unit 308 includes a display, a speaker, a display unit of the touch panel, or the like. The storage unit 309 includes a hard disk, a nonvolatile memory, or the like. The communication unit 310 includes a network interface or the like. The drive 311 drives a removable medium 312 such as a magnetic disk, an optical disc, a magneto-optical disk, a semiconductor memory, or the like.

The computer configured as described above causes the CPU 301 to load the program stored in, for example, the storage unit 309 into the RAM 303 through the input/output interface 305 and the bus 304 and execute the program, so as to perform the above-described series of processes.

The program executed by the computer (CPU 301) can be provided by being recorded on the removable medium 312 as a package medium or the like, for example.

Furthermore, the program can be provided via a wired or wireless transmission medium such as a local area network, the Internet, or digital satellite broadcasting.

In the computer, the program can be installed on the storage unit 309 via the input/output interface 305 by inserting the removable medium 312 into the drive 311. Furthermore, the program may be received by the communication unit 310 via a wired or wireless transmission medium and installed on the storage unit 309. Besides, the program can be installed in advance on the ROM 302 and the storage unit 309.

Note that the program executed by the computer may be a program that performs the processes in the time-series order described herein, or may be a program that performs the processes in parallel or at necessary timing such as when a call is made.

The software that performs the series of processes of the developing device 100 can be provided as, for example, development software.

An embodiment of the present technology is not limited to the embodiment described above, and various modifications can be made without departing from the scope of the present technology.

For example, it is possible to employ a mode obtained by combining all or some of the plurality of embodiments described above.

For example, the present technology may be embodied in cloud computing in which a function is shared and executed by a plurality of devices via a network.

Furthermore, each step described in the flowchart described above can be performed by one device or can be shared and performed by a plurality of devices.

Moreover, in a case where a plurality of processes is included in one step, the plurality of processes included in the one step can be performed by one device or performed by a plurality of devices in a shared manner.

Note that the effects described herein are merely examples and are not restrictive, and there may be effects other than those described herein.

Note that the present technology may have the following configurations.
(1) An imaging device including:
an acquisition unit that acquires a development size corresponding an image size at the time of development of a RAW image; and
a compression unit that compresses a captured image at a compression ratio corresponding to the development size acquired by the acquisition unit and by a compression method that compresses an image by decomposing the image into a plurality of spatial frequency components to generate the RAW image,
in which the compression ratio increases as the development size decreases.
(2) The imaging device according to the above (1),
in which
the compression method includes a compression method using a wavelet transform.
(3) The imaging device according to the above (1) or (2),
further including:
a recording control unit that records the RAW image generated by the compression unit on a recording medium in association with size information indicating the development size.
(4) The imaging device according to any one of the above (1) to (3),
further including:
a display control unit that controls a display of a setting screen for the development size,
in which
the acquisition unit acquires the development size set by a user on the setting screen.
(5) The imaging device according to the above (4),
in which
the setting screen includes a screen where one option selected by the user from among a plurality of options of the development size is set.
(6) The imaging device according to the above (4),
in which
the setting screen includes a screen where the development size input by the user is set.
(7) The imaging device according to any one of (1) to (6),
further including:
an imaging unit that acquires the captured image.
(8) An imaging method including:
by an imaging device,
acquiring, a development size corresponding an image size at the time of development of a RAW image; and
compressing, a captured image at a compression ratio corresponding to the development size acquired in the acquiring and by a compression method that compresses an image by decomposing the image into a plurality of spatial frequency components to generate the RAW image,
in which
the compression ratio increases as the development size decreases.
(9) A program causing a computer to function as an imaging device, the imaging device including:
an acquisition unit that acquires a development size corresponding to an image size at the time of development of a RAW image; and
a compression unit that compresses a captured image at a compression ratio corresponding to the development size acquired by the acquisition unit and by a compression method that compresses an image by decomposing the image into a plurality of spatial frequency components to generate the RAW image,
in which
the compression ratio increases as the development size decreases.
(10) An image processing method including:
by an image processing device,
acquiring, size information indicating a development size corresponding to an image size at the time of development of a RAW image, and the RAW image corresponding to a captured image compressed at a compression ratio corresponding to the development size and by a compression method that compresses an image by decomposing the image into a plurality of spatial frequency components; and
developing, the RAW image acquired in the acquiring to generate a developed image with the development size indicated by the size information acquired in the acquiring by decompressing the RAW image on the basis of the development size,
in which
the compression ratio increases as the development size decreases.
(11) The image processing method according to the above (10),
in which
the compression method includes a compression method using a wavelet transform.
(12) The image processing method according to the above (10) or (11),
in which
the size information includes recording size information indicating the development size set at the time of recording of the RAW image and post-recording size information indicating the development size set after recording of the RAW image,
the RAW image is compressed at the compression ratio corresponding to the development size indicated by the recording size information,
the post-recording size information of the size information is acquired in the acquiring, and
the RAW image is decompressed in the developing on the basis of the development size indicated by the post-recording size information acquired in the acquiring.
(13) The image processing method according to the above (12), further including:
receiving input of the development size,
in which in the acquiring, information indicating the development size of which the input has been received in the receiving is acquired as the post-recording size information.
(14) The image processing method according to claim 13, further including:
performing recording control to record, as the post-recording size information, information indicating the development size of which the input has been received in the receiving, on a recording medium in association with the RAW image,
in which
in the recording control, in a case where the post-recording size information has already been recorded in association with the RAW image, the post-recording size information is updated to the information indicating the development size of which the input has been received in the receiving, and
in the acquiring, the post-recording size information recorded in association with the RAW image is read from the recording medium for acquisition.
(15) A program causing a computer to function as an image processing device, the image processing device including:
an acquisition unit that acquires size information indicating a development size corresponding to an image size at the time of development of a RAW image, and the RAW image corresponding to a captured image compressed at a compression ratio corresponding to the development size and by a compression method that compresses an image by decomposing the image into a plurality of spatial frequency components; and
a development unit that decompresses the RAW image acquired by the acquisition unit to generate a developed image with the development size indicated by the size information acquired by the acquisition unit on the basis of the development size,
in which
the compression ratio increases as the development size decreases.

### REFERENCE SIGNS LIST

10 Imaging device
11 Image sensor
17 Lossy compression unit
18 Recording control unit
19 Control unit
21 Touch panel
30 Recording medium
100 Image processing device
101 Readout unit
104 Lossy compressed RAW processing unit
105 Development processing unit
109 Input unit
110 Recording control unit

1. An imaging device comprising:
an acquisition unit that acquires a development size corresponding an image size at a time of development of a RAW image; and
a compression unit that compresses a captured image at a compression ratio corresponding to the development size acquired by the acquisition unit and by a compression method that compresses an image by decomposing the image into a plurality of spatial frequency components to generate the RAW image,
wherein
the compression ratio increases as the development size decreases.

2. The imaging device according to claim 1,
wherein
the compression method includes a compression method using a wavelet transform.

3. The imaging device according to claim 1,
further comprising:
a recording control unit that records the RAW image generated by the compression unit on a recording medium in association with size information indicating the development size.

4. The imaging device according to claim 1,
further comprising:
a display control unit that controls a display of a setting screen for the development size,
wherein
the acquisition unit acquires the development size set by a user on the setting screen.

5. The imaging device according to claim 4,
wherein
the setting screen includes a screen where one option selected by the user from among a plurality of options of the development size is set.

6. The imaging device according to claim 4,
wherein
the setting screen includes a screen where the development size input by the user is set.

7. The imaging device according to claim 1,
further comprising:
an imaging unit that acquires the captured image.

8. An imaging method comprising:
by an imaging device,
acquiring, a development size corresponding an image size at a time of development of a RAW image; and
compressing, a captured image at a compression ratio corresponding to the development size acquired in the acquiring and by a compression method that compresses an image by decomposing the image into a plurality of spatial frequency components to generate the RAW image,
wherein
the compression ratio increases as the development size decreases.

9. A program causing a computer to function as an imaging device, the imaging device comprising:
an acquisition unit that acquires a development size corresponding to an image size at a time of development of a RAW image; and
a compression unit that compresses a captured image at a compression ratio corresponding to the development size acquired by the acquisition unit and by a compression method that compresses an image by decomposing the image into a plurality of spatial frequency components to generate the RAW image,
wherein
the compression ratio increases as the development size decreases.

10. An image processing method comprising:
by an image processing device,
acquiring, size information indicating a development size corresponding to an image size at a time of development of a RAW image, and the RAW image corresponding to a captured image compressed at a compression ratio corresponding to the development size and by a compression method that compresses an image by decomposing the image into a plurality of spatial frequency components; and
developing, the RAW image acquired in the acquiring to generate a developed image with the development size indicated by the size information acquired in the acquiring by decompressing the RAW image on a basis of the development size,
wherein
the compression ratio increases as the development size decreases.

11. The image processing method according to claim 10,
wherein
the compression method includes a compression method using a wavelet transform.

12. The image processing method according to claim 10,
wherein
the size information includes recording size information indicating the development size set at a time of recording of the RAW image and post-recording size information indicating the development size set after recording of the RAW image,
the RAW image is compressed at the compression ratio corresponding to the development size indicated by the recording size information,
the post-recording size information of the size information is acquired in the acquiring, and
the RAW image is decompressed in the developing on a basis of the development size indicated by the post-recording size information acquired in the acquiring.

13. The image processing method according to claim 12, further comprising:
receiving input of the development size,
wherein in the acquiring, information indicating the development size of which the input has been received in the receiving is acquired as the post-recording size information.

14. The image processing method according to claim 13, further comprising:
performing recording control to record, as the post-recording size information, information indicating the development size of which the input has been received in the receiving, on a recording medium in association with the RAW image,
wherein
in the recording control, in a case where the post-recording size information has already been recorded in association with the RAW image, the post-recording size information is updated to the information indicating the development size of which the input has been received in the receiving, and
in the acquiring, the post-recording size information recorded in association with the RAW image is read from the recording medium for acquisition.

15. A program causing a computer to function as an image processing device, the image processing device comprising:
an acquisition unit that acquires size information indicating a development size corresponding to an image size at a time of development of a RAW image, and the RAW image corresponding to a captured image compressed at a compression ratio corresponding to the development size and by a compression method that compresses an image by decomposing the image into a plurality of spatial frequency components; and
a development unit that decompresses the RAW image acquired by the acquisition unit to generate a developed image with the development size indicated by the size information acquired by the acquisition unit on a basis of the development size,
wherein
the compression ratio increases as the development size decreases.
